(19) United States
(12) Patent Application Publication
(10) Pub. No.: US 2011/0189408 A1
(43) Pub. Date: Aug. 4, 2011

(54) PARTICULATE SUBSTANCE FOR FILLING ARTIFICIAL TURF AND ARTIFICIAL TURF STRUCTURE FILLED WITH THE PARTICULATE SUBSTANCE FOR FILLING ARTIFICIAL TURF

(76) Inventors: Takeshi Ishimaru, Hyogo (JP); Hideyuki Okuyama, Hyogo (JP)

(21) Appl. No.: 12/808,352

(22) PCT Filed: Nov. 28, 2008
(86) PCT No.: PCT/JP2008/003513

§ 371 Date: Apr. 26, 2011

(30) Foreign Application Priority Data
Dec. 27, 2007 (JP) 2007-335528

(51) Int. Cl. A41G 1/00; B32B 5/16

(52) U.S. Cl. 428/17; 428/402

(57) ABSTRACT

A recycling technique for long-pile artificial turfs is provided in which a spent artificial turf is recycled and formed into an elastic particulate substance suitable for use as a filler for long-pile artificial turfs. The particulate substance (5), with which the space among the piles (4) of an artificial turf (3) is filled, is obtained by using as a raw material an artificial turf comprising at least 50 wt. % thermoplastic resin, adding an elastomer to the raw material, and forming the resultant mixture into particles. The particulate substance (5) has a specific gravity regulated to 1.10 or higher and is used for the filling.

### TECHNICAL FIELD

The present invention relates to a particulate substance for filling an artificial turf with which the space between the piles of an artificial turf is filled, more particularly to a particulate substance for filling an artificial turf which is recycled from a spent artificial turf.

### BACKGROUND ART

Artificial turfs such as an artificial turf containing sand and a long pile artificial turf have spread widely as a surface for various sports. Generally, this type of artificial turf structure needs to be renewed after the elapse of its lifetime due to the deterioration of a resin or the break of a pile.

At this time, the spent artificial turf is removed and then disposed of as industrial waste, which is not environmentally desirable. Under these circumstances, there has recently been proposed various techniques for a method of reusing a part of the artificial turf or for an artificial turf which is easily recycled, without treating the artificial turf as industrial waste. A part thereof will be described below.

Patent Document 1 discloses a recyclable artificial turf using nylon 6 as a material in the artificial turf. This patent shows an embodiment in which a recovered artificial turf can be smoothly recycled to a raw material by using nylon 6.

Patent Document 2 discloses an artificial turf prepared by fixing a pile to a primary backing using a thermoplastic resin. According to this patent, the artificial turf itself can be recycled as a raw material for recycling.

Patent Document 1: Japanese Patent Laid-Open No. H9-242011

### Patent Document 2: Japanese Patent Laid-Open No. 2000-17605

### DISCLOSURE OF THE INVENTION

### Problems to be Solved by the Invention

However, both of the above Patent Documents 1, 2 are premised on completely removing the filled particulate substance from the artificial turf. Actually, since the particulate substance gets wet or is stepped on and hardened with time, it is almost impossible to completely remove the particulate substance entering the pile.

Particularly with respect to the particulate substance filled in a long pile artificial turf, the turf has been filled with an elastic particulate substance such as a rubber chip and a hard particulate substance such as sand, these two types of fillers having been stacked, for example, in two layers in order to obtain a filling and properties close to natural turf. Therefore, it has been particularly difficult to separately recover these particulate substances.

Therefore, even if the recycling techniques described in Patent Documents 1 and 2 were used, it was difficult to recycle artificial turfs to a raw material with high purity because a particulate substance inevitably remained in artificial turfs as impurities. On the other hand, there is a so-called thermal recycling method in which such an artificial turf waste is used as a fuel. However, when an environmental problem is taken into consideration, this method cannot be said to be a desirable method.

As an example of the methods for solving this problem, there is considered a method of using the same raw material for forming the artificial turf as the raw material for forming the particulate substance. Material recycling is possible by using this method because even if the particulate substance is left behind between the piles of the artificial turf, they can be treated the same raw material.

However, even if they are produced by using the same raw material, there are still following problems. That is, when the artificial turf is actually melted and mixed, the recycled article will be very hard and not elastic like rubber. Therefore, even when the recycled article is formed into particles and the artificial turf is filled with the particles, it has been impossible to create the softness close to natural turf which the long pile artificial turf originally has.

Thus, in order to solve the problems as described above, the present invention provides a recycling technique for long-pile artificial turfs in which a spent artificial turf is recycled and formed into an elastic particulate substance suitable for use as a filler for long-pile artificial turfs.

### Means for Solving the Problems

In order to achieve an object mentioned above, the present invention has several features shown below. In accordance with claim 1 of the present invention, a particulate substance for filling an artificial turf is provided, the artificial turf comprising a primary backing, piles implanted in the primary backing, and a coating material for fixing the piles to the primary backing provided on the back side of the primary backing, the space between the piles of the artificial turf being filled with the particulate filler, wherein the particulate substance is obtained by using as a raw material the artificial turf comprising a thermoplastic resin in an amount of at least 50% by weight, adding an elastomer to the raw material, and forming the resultant mixture into particles, and wherein the particulate substance has a specific gravity regulated to 1.10 or higher.

In accordance with claim 2 of the present invention, the particulate substance for filling an artificial turf has a hardness as measured in accordance with the JIS-K6253 type A method of 50 to 80 in the particulate substance for filling an artificial turf according to claim 1.

In accordance with claim 3 of the present invention, at least 95% by weight of the particulate substance for filling an artificial turf pass through a 2.83 mm screen specified in JIS-Z8801 when the particulate substance is sieved by the method according to JIS-K6316 in the particulate substance for filling an artificial turf according to claim 1 or 2.

The present invention further includes an artificial turf structure wherein the space between piles is filled with a particulate substance for filling an artificial turf according to any one of claims 1 to 3.

### Advantages of the Invention

In accordance with claim 1 of the present invention, the particulate substance is obtained by using as a raw material an artificial turf comprising a thermoplastic resin in an amount of at least 50% by weight, adding an elastomer to the raw material, and forming the resultant mixture into particles, wherein the particulate substance has a specific gravity regulated to 1.10 or higher. Thus, these materials are uniformly mixed with each other during the melting, and it is possible to prepare a particulate substance which is based on the same raw material as that of the artificial turf and has proper elasticity.

Further, the particulate substance is regulated to a specific gravity of 1.1 or higher. As a result, the scattering of the particulate substance or the outflow thereof with rain can be prevented. As an example of the method of increasing the specific gravity of the particulate substance, there is mentioned a method of adding an additive such as calcium carbonate.

In accordance with claim 2 of the present invention, the particulate substance has a hardness as measured in accordance with the JIS-K6253 type A method of 50 to 80. Thus, it is possible to obtain properties close to natural turf when the artificial turf is filled with this particulate substance.

When the hardness of the particulate substance is less than 50, the particulate substance will be deformed by the application of repeated tread pressure, and it will be compacted. Therefore, such a low hardness is not desirable. Conversely, if the hardness exceeds 80, the particulate substance will be too hard and will cause an abrasion or the like in the case of sliding on the turf. Therefore, such a high hardness is not desirable as well.

In accordance with claim 3 of the present invention, at least 95% by weight of the particulate substance pass through a 2.83 mm screen specified in JIS-Z8801 when the particulate substance is sieved by the method according to JIS-K6316. Thus, when the artificial turf is filled with such a particulate substance, the particulate substance will not be easily kicked out or scattered by the motion of people.

### BRIEF DESCRIPTION OF THE DRAWING

FIG. 1 is a sectional view showing a major portion of an artificial turf structure according to one embodiment of the present invention.

### DESCRIPTION OF SYMBOLS

1 Artificial turf structure
2 Roadbed
3 Artificial turf
31 primary backing
32 coating material
4 Pile
5 Particulate substance

### BEST MODE FOR CARRYING OUT THE INVENTION

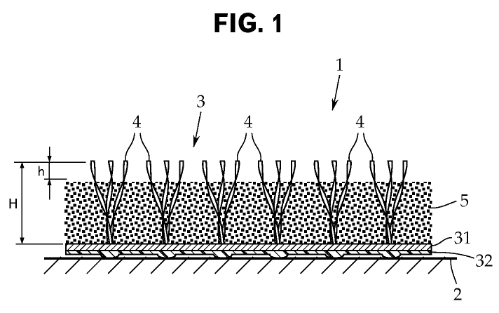

Next, an embodiment of the present invention will be described referring to the drawing, but the present invention is not limited to it. FIG. 1 is a sectional view showing a major portion of an artificial turf structure according to one embodiment of the present invention. This artificial turf structure 1 has an artificial turf 3 laid on a base 2, and the space between piles 4 of the artificial turf 3 is filled with a particulate substance 5.

A low cost road pavement surface in which a ground surface is leveled evenly is used as the base 2. However, the ground may be covered with gravel or the like in addition to the above, or an existing pavement surface paved with asphalt or the like may also be used. Further, an elastic pavement or the like may be provided on the base 2. In the present invention, the structure of the base 2 can be changed depending on specification and is an arbitrary matter.

An artificial turf 3 comprises a primary backing 31 and piles 4 implanted therein with a predetermined interval. A material for the primary backing 31 is preferably selected from a thermoplastic resin such as polypropylene and polyethylene, but low density polyethylene with good meltability is more preferred in consideration of recyclability.

Although a plain-weave cloth made using a synthetic resin such as polypropylene and polyethylene is used for the primary backing 31 in this embodiment, a cotton-like material of a synthetic resin may be planted by punching in addition to this. Note that, although the color of the primary backing 31 is arbitrarily determined depending on specification, the primary backing is preferably colored in a color other than black so that it may hardly absorb solar heat when it is formed into a particulate substance.

The pile 4 is preferably a so-called long pile having a pile length H from the surface of the primary backing 31 to the tip thereof of from 40 to 75 mm. A material for the pile 4 is preferably selected from a thermoplastic resin such as polypropylene and polyethylene, but low density polyethylene with good meltability is more preferred in consideration of recyclability. Although the pile 4 is colored in green, arbitrary colors other than black may be used.

A bundle of a plurality of monotape yarns or monofilament yarns, or a band of split yarn may be used for the pile 4. In this embodiment, the pile 4 has a size of 8,000 to 11,000 dtex and is planted in the primary backing 31 in a planting amount of 1,000 to 2,000 g/m³.

In order to prevent the tufted pile 4 from being dropped off, a coating material 32 is uniformly applied to the back of the primary backing 31. Although a thermosetting resin such as SBR latex or urethane is used for the coating material 32, an extender such as calcium carbonate is optionally added thereto.

In this embodiment, the coating material 32 is uniformly applied so that the coating amount may be from 600 to 800 g/m² (after drying). The coating material 32 is preferably colored in a color other than black in consideration of the color of the particulate substance for recycling that will be exhibited thereby when it is recycled.

In the present invention, the primary backing 31 and the pile 4 is made using a thermoplastic resin which is easily melted by heating such as polypropylene and polyethylene in consideration of recyclability. A thermosetting resin such as SBR latex is used for the coating material 5 in consideration of workability and the like.

The artificial turf 3 comprises a composite of a thermoplastic resin and a thermosetting resin. Therefore, when the artificial turf 3 is melted by heating, the thermosetting resin will be uniformly dispersed in the thermoplastic resin, thus forming a single raw material in which both resins are mixed with each other. Thus, the present invention is constituted so that the content of a thermoplastic resin may be 50% by weight or more of the total resin amount (100% by weight) including the coating material 32.

That is, when the content of a thermoplastic resin is less than 50% by weight of the whole, the thermosetting resin such as a resin for the coating material 32, if present, will not be uniformly dispersed in the melted thermoplastic resin, and there is a risk that the mixture cannot be treated as a single material. Therefore, such low content is not desirable.

A material other than a thermoplastic resin can be selected for the coating material 32 in consideration of processability, cost, and the like if the material can fix the pile 4 and satisfies the dimensional stability of the artificial turf 3. However, it is more effective to use a relatively soft material such as SBR and urethane in order to impart moderate elasticity to the particulate substance 5 when the artificial turf is recycled.

The space between the piles 4 of the artificial turf 3 prepared in this way is filled with the particulate substance 5. In the present invention, the particulate substance 5 is formed into particles by using the artificial turf 3 as a raw material and adding an elastomer to the raw material.

In this embodiment, although the particulate substance 5 is composed only of a recycled particulate substance 5 prepared by remelting the waste of a spent artificial turf 3 and forming the melt into particles, the particulate substance 5 may be a newly produced one as long as it contains a predetermined amount of thermoplastic resin which is the same raw material as the raw material in the artificial turf 3.

The particulate substance 5 prepared in this way preferably has a hardness as measured in accordance with the JIS-K6253 type A method of 50 to 80. This allows properties close to natural turf to be obtained even if the artificial turf is filled with a single type of recycled particulate substance 5.

When the hardness of the particulate substance is less than 50, the particulate substance will be deformed by the application of repeated tread pressure, and it will be compacted. Therefore, such a low hardness is not desirable. Conversely, if the hardness exceeds 80, the particulate substance will be too hard and will cause an abrasion or the like in the case of sliding on the turf. Therefore, such a high hardness is not desirable as well.

In the present invention, the particulate substance 5 is prepared by using an artificial turf as a raw material and mixing an elastomer with the raw material. Since 50% by weight or more of the raw material in the artificial turf is a thermoplastic resin such as PP and PE, it is expected that the particulate substance has a specific gravity of 1.0 or less.

If the particulate substance has a specific gravity of 1.0 or less, it will be not only easily carried away by wind and rain but also easily kicked out or scattered during the game of soccer or the like. Thus, the particulate substance 5 is regulated so that it has a specific gravity of 1.10 or higher. An example of the methods for increasing the specific gravity includes a method of adding an additive such as calcium carbonate, but the specific gravity may be increased by any method other than this.

In this embodiment, the particulate substance 5 is formed into a predetermined particle so that it can easily enter the space between the piles 4 of the artificial turf 3. The particulate substance 5 more preferably has such a size that at least 95% by weight of the particulate substance pass through a 2.83 mm screen specified in JIS-Z8801 when the particulate substance is sieved through the screen by the method according to JIS-K6316. A larger particulate substance 5 which does not pass through the screen will be easily kicked out after the artificial turf 3 is filled with it and may cause scattering. Therefore, such a large particulate substance is not desirable.

The particulate substance 5 is prepared by suitably adding other materials to the thermally molten waste of the artificial turf 3 in order to impart color, weight, elasticity and the like. Therefore, when the particulate substance is recycled, it can be formed into an equivalent particulate substance 5 by controlling the amount of additives to be added to the thermally molten mixture thereof with the artificial turf 3. The artificial turf and the particulate substance can be thus treated as the same raw material.

The particulate substance 5 preferably consists of a single type of filler. Specifically, if the particulate substance 5 contains a mixture of plural types of particulate substances, when the particulate substance is removed from the artificial turf and a newly laid artificial turf is filled with the particulate substance, the particulate substance must be classified for each type after it is removed from the artificial turf. In addition, since the proportion of the types of the particulate substances removed from the artificial turf 3 may not be uniform, the resulting artificial turf structure may not have the same properties as those before recycling when the artificial turf is filled again with such a particulate substance.

The particulate substance 5 is preferably colored in a predetermined color, and more preferably colored in a color other than black. According to this, it is possible not only to obtain an aesthetic appearance close to an artificial turf or the ground, but to prevent a buildup of heat by absorbing sunlight, by coloring the particulate substance 5, for example, in a green-based color or a brown-based color, respectively. For this purpose, the pile, the primary backing, and the coating material in the artificial turf used as a raw material are preferably colored in a color other than black.

The filling thickness of the particulate substance 5 is arbitrarily selected by the elasticity demanded, but the thickness is preferably selected so that the projection height h of the pile 4 (the length from the top of the layer filled with the particulate substance to the tip of the pile) is from 10 to 30 mm in order to prevent an outflow or scattering of the particulate substance 5.

According to the present invention, a spent artificial turf 1 is recovered from a roadbed, the recovered turf is heated and melted to form the melt into a particulate substance, and then the particulate substance for recycling is placed again as a particulate substance of an artificial turf newly laid on a roadbed. Thus, the artificial turf can be recycled as a material for the artificial turf application and a circulation type recycling system can be established.

### EXAMPLES

Hereinafter, Examples 1 to 4 of the present invention and Comparative Example 1 to 3 will be described. First, the artificial turf and the particulate substance were prepared by the following methods.

### (Preparation of Artificial Turf)

A split yarn made using low density polyethylene (size: 11,000 dtex) was implanted in a primary backing made using polypropylene (weight: 100 g/m²) by tufting in a mass per unit area of 1300 g/m² so that the yarn forms a grass having a length of 50 mm. Next, a latex prepared from a mixture of SBR and calcium carbonate (mixing ratio; SBR:calcium carbonate=1:2) was applied to the back side of the primary backing as a coating material, and then the latex was dried to produce an artificial turf.

Since the product weight at this time was 2,150 g/m², it was determined that the dry weight of the coating material was 750 g/m² (SBR 250 g/m²: calcium carbonate 500 g/m²).

### (Preparation of Particulate Substance)

A bulk material prepared by melting the newly prepared artificial turf was ground to prepare a chip. An elastomer (LQA9102S manufactured by Riken Technos Corp. (hardness: 20°)) and calcium carbonate (BF300 manufactured by Bihoku Funka Kogyo Co., Ltd. (specific gravity: 2.7)) described in each Example and each Comparative Example were added to the chip as shown in Table 1, heated, and mixed to prepare a particulate substance.

### (Construction of Sample Turf)

The above artificial turf was laid on a roadbed with a size of 1 m×5 m and then filled with each of the particulate substances in Examples 1 to 4 and Comparative Examples 1 to 3 with a thickness of 30 mm to prepare a sample turf, which was then subjected to each of the following evaluations.

### (Measurement and Evaluation of Hardness)

Each of the samples in Examples 1 and 2 and Comparative Examples 1 to 4 was injection-molded into a cylindrical shape having a size of 28 mm in diameter×12.7 mm in height, followed by measuring hardness in accordance with the JIS-K6253 type A method.

### (Evaluation by Screen Measurement)

A 2.83 mm screen specified in JIS-Z8801 was prepared. The screen was used to sieve 300 g of the particulate substance by the method according to JIS-K6316, and the percent by weight of the particulate substance remaining on the screen was measured.

### (Evaluation of Impact Absorption Characteristics)

The impact absorption of each sample turf after construction was evaluated by DIN18032 impact absorption test.

### (Evaluation of an Abrasion)

The degree of an abrasion was checked after running and sliding on a sample turf.

(Evaluation of Change in Properties with Time)

A sample turf was allowed to stand half a year in a state in which it can be freely walked, and the scattering situation of a particulate substance, impact absorption, and the degree of deformation were visually checked.

The results of the measurements are shown below.

### Example 1

Percentage of thermoplastic resin in artificial turf: 65%
Percentage of artificial turf recycled chip: 50%
Percentage of elastomer: 30%
Calcium carbonate content: 20%

### Evaluation of Properties of Particulate Substance

Specific gravity: 1.16, weight passing through screen: 98 wt %, Hardness: 75

### Evaluation of Sample Turf (at the Time of Construction)

Impact absorption: 58%, Degree of an abrasion: almost nothing

### Evaluation of Sample Turf (After Half a Year)

Scattering of particulate substance: almost nothing, Impact absorption: 52%, Deformation of particulate substance: not deformed

### Example 2

Percentage of thermoplastic resin in artificial turf: 65%
Percentage of artificial turf recycled chip: 30%
Percentage of elastomer: 50%
Calcium carbonate content: 20%

### Evaluation of Properties of Particulate Substance

Specific gravity: 1.12, weight passing through screen: 100 wt %, Hardness: 50

### Evaluation of Sample Turf (at the Time of Construction)

Impact absorption: 54%, Degree of an abrasion: nothing

### Evaluation of Sample Turf (After Half a Year)

Scattering of particulate substance: almost nothing, Impact absorption: 52%, Deformation of particulate substance: not deformed

### Example 3

Percentage of thermoplastic resin in artificial turf: 75%
Percentage of artificial turf recycled chip: 50%
Percentage of elastomer: 30%
Calcium carbonate content: 20%

### Evaluation of Properties of Particulate Substance

Specific gravity: 1.15, weight passing through screen: 97 wt %, Hardness: 80

### Evaluation of Sample Turf (at the Time of Construction)

Impact absorption: 52%, Degree of an abrasion: almost nothing

### Evaluation of Sample Turf (After Half a Year)

Scattering of particulate substance: almost nothing, Impact absorption: 50%, Deformation of particulate substance: not deformed

### Example 4

Percentage of thermoplastic resin in artificial turf: 65%
Percentage of artificial turf recycled chip: 40%
Percentage of elastomer: 40%
Calcium carbonate content: 20%

### Evaluation of Properties of Particulate Substance

Specific gravity: 1.13, weight passing through screen: 96 wt %, Hardness: 65

### Evaluation of Sample Turf (at the Time of Construction)

Impact absorption: 55%, Degree of an abrasion: nothing

### Evaluation of Sample Turf (After Half a Year)

Scattering of particulate substance: almost nothing, Impact absorption: 40%, Deformation of particulate substance: not deformed

### Comparative Example 1

Percentage of thermoplastic resin in artificial turf: 65%
Percentage of artificial turf recycled chip: 30%
Percentage of elastomer: 60%
Calcium carbonate content: 10%

### Evaluation of Properties of Particulate Substance

Specific gravity: 1.04, weight passing through screen: 95 wt %, Hardness: 65

### Evaluation of Sample Turf (at the Time of Construction)

Impact absorption: 54%, Degree of an abrasion: nothing

### Evaluation of Sample Turf (After Half a Year)

Scattering of particulate substance: scattered, Impact absorption: 52%, Deformation of particulate substance: not deformed

### Comparative Example 2

Percentage of thermoplastic resin in artificial turf: 45%
Percentage of artificial turf recycled chip: **%
Percentage of elastomer: **%
Calcium carbonate content: **%

### Evaluation of Properties of Particulate Substance

Specific gravity: ***, weight passing through screen: ** wt %, Hardness: **

### (Evaluation of Sample Turf (at the Time of Construction))

Impact absorption: **%, Degree of an abrasion: **

### (Evaluation of Sample Turf (After Half a Year))

Scattering of particulate substance: **, Impact absorption: **%, Deformation of particulate substance: ** deformed

### Comparative Example 3

Percentage of thermoplastic resin in artificial turf: 65%
Percentage of artificial turf recycled chip: 70%
Percentage of elastomer: -%
Calcium carbonate content: 30%

### Evaluation of Properties of Particulate Substance

Specific gravity: 1.18, weight passing through screen: 97 wt %, Hardness: 96

### Evaluation of Sample Turf (at the Time of Construction)

Impact absorption: 42%, Degree of an abrasion: an abrasion occurred

### Evaluation of Sample Turf (After Half a Year)

Scattering of particulate substance: almost nothing, Impact absorption: 40%, Deformation of particulate substance: not deformed

Table 1 below summarizes the properties and evaluation results of the fillers in Examples 1 to 4 and Comparative Examples 1 to 3.

TABLE 1

| | | | | | Properties of filler | | |
|---|---|---|---|---|---|---|---|
| | Percentage of | | | | | Weight | |
| | thermoplastic | | | | | passing | |
| | resin in | Percentage of | Percentage | Calcium | | through | |
| | artificial turf | artificial turf | of | carbonate | Specific | 2.83 mm | Hardness |
| | [wt %] | recycled chip | elastomer | content | gravity | screen [wt %] | [Type A] |
| Example 1 | 65% | 50% | 30% | 20% | 1.16 | 98 | 75 |
| Example 2 | 65% | 30% | 50% | 20% | 1.12 | 100 | 50 |
| Example 3 | 75% | 50% | 30% | 20% | 1.15 | 97 | 80 |
| Example 4 | 65% | 40% | 40% | 20% | 1.13 | 96 | 65 |
| Comparative | 65% | 30% | 60% | 10% | 1.04 | 95 | 65 |
| Example 1 | | | | | | | |
| Comparative | 45% | * | * | * | * | * | * |
| Example 2 | | | | | | | |
| Comparative | 65% | 70% | — | 30% | 1.18 | 97 | 96 |
| Example 3 | | | | | | | |

| | Evaluation of sample turf | | | | |
|---|---|---|---|---|---|
| | At the time | | | | |
| | of construction | | After half a year | | |
| | Impact | | | Impact | Deformation |
| | absorption | Degree of | Scattering | absorption | of |
| | [%] | an abrasion | filler | [%] | filler |
| Example 1 | 58 | Almost | Almost | 52 | Not deformed |
| | | nothing | nothing | | |
| Example 2 | 54 | nothing | Almost | 52 | Not deformed |
| | | | nothing | | |
| Example 3 | 52 | Almost | Almost | 50 | Not deformed |
| | | nothing | nothing | | |
| Example 4 | 55 | nothing | Almost | 40 | Not deformed |
| | | | nothing | | |
| Comparative | 54 | nothing | Scattered | 52 | Not deformed |
| Example 1 | | | | | |
| Comparative | * | * | * | * | * |
| Example 2 | | | | | |
| Comparative | 42 | an abrasion | Almost | 40 | Not deformed |
| Example 3 | | ocuured | nothing | | |

*: Since the percentage of the thermoplastic resin in the raw material in the artificial turf is 45%, the material are not uniformly mixed with each other by melting, and it is impossible to produce recycled chips.

The following findings were obtained as a result of comparing Examples with Comparative Examples.

(1) In Comparative Example 1, since the specific gravity is 1.10 or less, the scattering is significant.
(2) In Comparative Example 2, since the percentage of the thermoplastic resin in the raw material in the artificial turf is 45% (less than 50%), the materials were not uniformly mixed with each other by melting, and it was impossible to produce recycled chips.
(3) In Comparative Example 3, since the elastomer is not added to the raw material, the resulting particulate substance is hard. Therefore, in the case of sliding on the artificial turf filled with this particulate substance, the particulate substance may cause an abrasion.

1.-4. (canceled)

5. A particulate substance for filling an artificial turf, the artificial turf comprising a primary backing made using a synthetic resin, piles made using a synthetic resin implanted in the primary backing, and a backing material comprising a thermosetting resin for fixing the piles to the primary backing provided on the back side of the primary backing, the space between the piles of the artificial turf being filled with the particulate filler, wherein the particulate substance is obtained by using as a raw material the artificial turf comprising a thermoplastic resin in an amount of at least 50% by weight based on the total resin amount including the coating material, adding an elastomer to the raw material, and heating and melting the raw material and the elastomer to form particles in which the raw material is mixed with the elastomer, and wherein the particulate substance has a specific gravity regulated to 1.10 or higher.

6. The particulate substance for filling an artificial turf according to claim 5, wherein the particulate substance has a hardness as measured in accordance with the JIS-K6253 type A method of 50 to 80.

7. The particulate substance for filling an artificial turf according to claim 5 or 6, wherein at least 95% by weight of the particulate substance pass through a 2.83 mm screen specified in JIS-Z8801 when the particulate substance is sieved by the method according to JIS-K6316.

8. An artificial turf structure wherein the space between the piles is filled with a particulate substance for filling an artificial turf according to claim 5.
